(19) United States
(12) Patent Application Publication
(10) Pub. No.: US 2021/0331894 A1
(43) Pub. Date: Oct. 28, 2021

(54) ELEVATOR SYSTEM AND ELEVATOR CAR

(71) Applicant: Otis Elevator Company, Farmington, CT (US)

(72) Inventors: DaYu Chen, Shanghai (CN); Shaohong Jiang, Shanghai (CN)

(21) Appl. No.: 17/097,082

(22) Filed: Nov. 13, 2020

(30) Foreign Application Priority Data
Apr. 24, 2020 (CN) 202010333104.X

(51) Int. Cl. B66B 5/28; B66B 11/02; B66B 5/16; B66B 7/04

(52) U.S. Cl. CPC B66B 5/282; B66B 7/042; B66B 5/16; B66B 11/0226

(57) ABSTRACT

An elevator system and an elevator car. The elevator system includes one or more elevator cars traveling in an elevator hoistway along a guide rail, a shock absorbing device and a buffering device, the shock absorbing device is installed on at least one outside surface of the elevator car, and the buffering device is installed on an inside wall and/or a bottom of the elevator hoistway and configured to contact the shock absorbing device when the elevator car travels to lowest position along the guide rail.

### FOREIGN PRIORITY

This application claims priority to Chinese Patent Application No. 202010333104.X, filed Apr. 24, 2020, and all the benefits accruing therefrom under 35 U.S.C. § 119, the contents of which in its entirety are herein incorporated by reference.

### FIELD OF THE INVENTION

The disclosure relates to the technical field of elevators and, more particularly, to an elevator system and an elevator car.

### BACKGROUND OF THE INVENTION

Elevators have received widespread applications in modern society, and can bring great convenience to people's production and living activities, etc. However, for some old houses or office buildings, special workshops, historical buildings, etc., such elevators have not been able to be equipped due to many reasons, thereby leading to a lot of inconveniences. In particular, as the problem of an aging society becomes increasingly prominent, the demand for installing elevators in old communities is becoming more and more intense. However, in order to install elevators in such environments, the construction will face many difficulties. For example, the on-site construction conditions of an elevator hoistway are usually complicated, and the workload of civil construction is heavy. Building the hoistway by excavating may not only affect the safety of the building structure, but also needs to relocate many complex underground pipelines such as natural gas pipelines, communication pipelines, and water supply and drainage pipelines, and it is easy to accumulate water in the elevator hoistway during future use, which makes it difficult to maintain and will adversely affect a safe operation of the equipment.

### SUMMARY OF THE INVENTION

In view of the foregoing, the disclosure provides an elevator system and an elevator car, thereby solving or at least alleviating one or more of the above problems and problems of other aspects.

Firstly, according to a first aspect of the disclosure, an elevator system is provided, which includes one or more elevator cars traveling in an elevator hoistway along a guide rail, a shock absorbing device and a buffering device, wherein the shock absorbing device is installed on at least one outside surface of the elevator car, and the buffering device is installed on an inside wall and/or a bottom of the elevator hoistway and configured to contact the shock absorbing device when the elevator car travels to lowest position along the guide rail.

In the elevator system according to the disclosure, optionally, the elevator system further includes: a safety device installed on at least one outside surface of the elevator car and configured to apply a braking force to the elevator car when an overspeed occurs in the elevator car; and/or a stopping device installed on at least one outside surface of the elevator car and connected to a control switch in the elevator system, and configured to make the elevator car stop traveling through the stopping device after the control switch is triggered.

In the elevator system according to the disclosure, optionally, the shock absorbing device includes at least two shock absorbers, the buffering device includes at least two buffers, the at least two shock absorbers are respectively installed on two mutually opposed outside surfaces of the elevator car, and the at least two buffers are respectively installed on two mutually opposed inside walls of the elevator hoistway and/or two mutually opposed positions on the bottom.

In the elevator system according to the disclosure, optionally, the buffers are each configured to have a support portion and a buffering portion, the support portions are installed on the two mutually opposed inside walls and/or the two mutually opposed positions, and the buffering portion are disposed on the support portions and are made of an elastic material.

In the elevator system according to the disclosure, optionally, the buffer further has a spring, which is disposed between the support portion and the buffering portion and/or disposed in the buffering portion.

In the elevator system according to the disclosure, optionally, the shock absorber is configured to have a fixed portion and a contact portion, the fixed portion is fixed to the two mutually opposed outside surfaces, the contact portion is connected to the fixed portion and contacts the buffering portion when the elevator car travels to the lowest position along the guide rail.

In the elevator system according to the disclosure, optionally, the shock absorber further has a reinforcing portion connected to the fixed portion and the contact portion.

In the elevator system according to the disclosure, optionally, the outside surface of the elevator car is provided with a guide shoe, the elevator car travels in the elevator hoistway along the guide rail through the guide shoe, and at least two of the guide shoe, the shock absorbing device, the safety device, and the stopping device are installed together on at least one outside surface of the elevator car.

In the elevator system according to the disclosure, optionally, the guide shoe, the shock absorbing device, the safety device, and the stopping device are all installed on a lower side of at least one outside surface of the elevator car.

In the elevator system according to the disclosure, optionally, the elevator hoistway is at least partially disposed outside of a building where the elevator system is installed.

In the elevator system according to the disclosure, optionally, when the elevator car is at the lowest position, a floor surface of the elevator car is 200-300 mm higher than a site ground surface of the building where the elevator system is installed.

Additionally, according to a second aspect of the disclosure, an elevator car is further provided, wherein the elevator car is the elevator car in any one of the elevator systems as described above.

The principles, features, characteristics, advantages and the like of the various technical solutions according to the disclosure will be clearly understood from the following detailed description in combination with the accompanying drawings. The elevator system and elevator car according to the disclosure are easy to manufacture, install and maintain, and can adapt to complex site installation conditions, effectively reducing costs and the workload of civil construction, shortening elevator installation time, and avoiding or reducing adverse effects on the building structure. The problems which often exist in the related art that it is easy to accumulate water in the future because of the need to build the elevator hoistway by excavating, and difficult to maintain the elevator so that the safety of elevator operation will be affected, can be solved. The disclosure has strong practicability, and is particularly suitable for elevator installation and reconstruction in old communities.

### BRIEF DESCRIPTION OF THE DRAWINGS

The technical solutions of the disclosure will be further described in detail below with reference to the accompanying drawings and embodiments. However, it should be understood that these drawings are designed merely for the purpose of explanation and only intended to conceptually illustrate the structural configurations described herein, and are not required to be drawn to scale.

FIG. 1 is a schematic structural top view of an embodiment of an elevator system according to the disclosure.

FIG. 2 is a schematic partial structural perspective view of an elevator car and an elevator hoistway in the embodiment of the elevator system shown in FIG. 1.

FIG. 3 is a schematic partial structural side view of the elevator car and the elevator hoistway in the embodiment of the elevator system shown in FIG. 1, wherein a guide rail and a car body of the elevator car are omitted.

FIG. 4 is a schematic structural perspective view of an example of a pair of shock absorber and buffer cooperating with each other in the embodiment of the elevator system shown in FIG. 1.

### DETAILED DESCRIPTION OF THE EMBODIMENT(S) OF THE INVENTION

First, it is noted that the structural components, arrangements, characteristics, advantages and the like of the elevator system and the elevator car according to the disclosure will be described below by way of example. However, all the descriptions are not intended to limit the disclosure in any way. Herein, the technical term “connect (or connected, etc.)” covers a situation where a specific component is directly connected to another component and/or indirectly connected to another component, the technical terms “upper”, “lower”, “right”, “left”, “vertical”, “horizontal” and their derivatives should be related to the orientations in individual drawings, and it should be understood that the disclosure can take various alternative orientations.

In addition, for any single technical feature described or implied in the embodiments mentioned herein, or any single technical feature depicted or implied in the accompanying drawings, the disclosure still allows for any combination or deletion of these technical features (or equivalents thereof) without any technical obstacles, so these further embodiments according to the disclosure should also be considered to be within the scope recorded in the disclosure. In addition, for the sake of brevity, identical or similar parts and features may be marked in only one place or several places in the same drawing, and general items that are well known to those skilled in the art will not be described in detail herein.

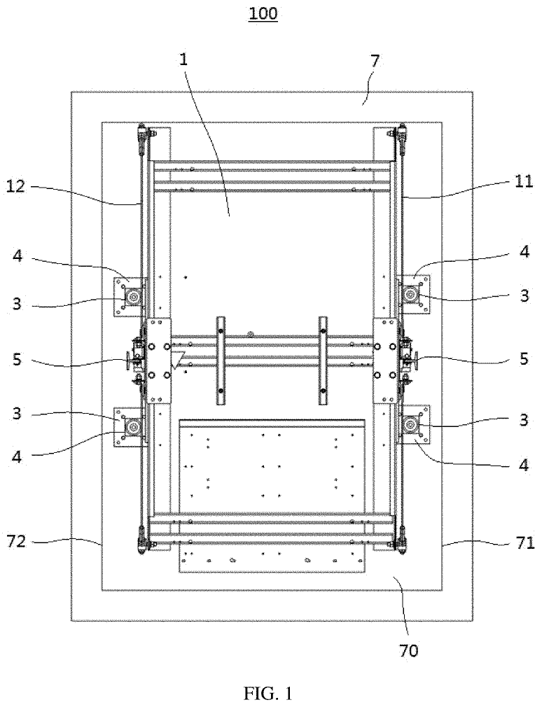

Reference is firstly made to FIG. 1, in which a general composition and arrangement of an embodiment of an elevator system according to the disclosure are schematically illustrated in a top view, and the technical solution of the disclosure will be described in detail through this embodiment.

As shown in FIG. 1, in an elevator system 100, one or more elevator cars 1 may be equipped according to actual needs. When in use, the elevator car 1 will travel in an elevator hoistway 7 along a guide rail 2 that plays a guiding role. For example, a rigid guide rail 2 may be fixedly installed in the elevator hoistway 7 along the vertical direction, so that the elevator car 1, when driven by a power provided by an electric motor for example, moves up and down in the elevator hoistway 7 along the guide rail 2.

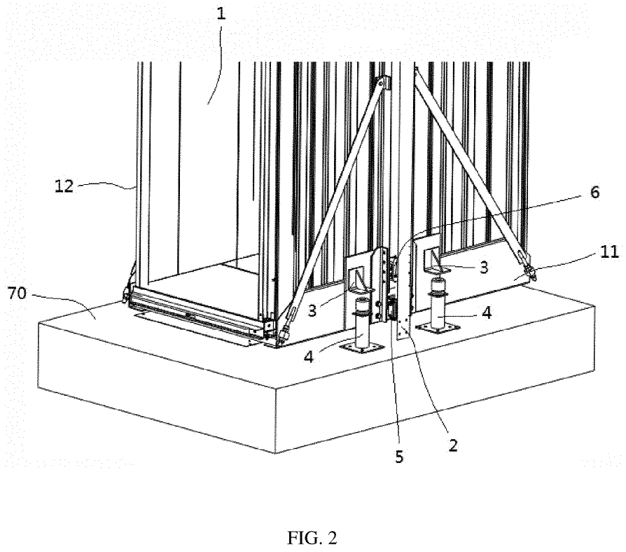

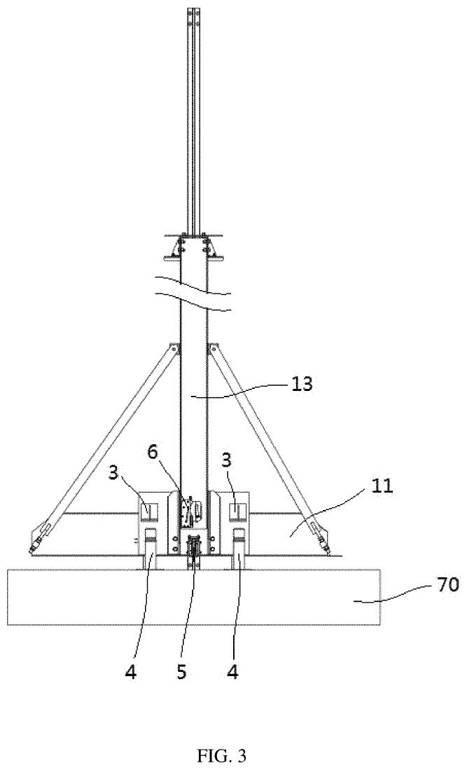

FIG. 1, FIG. 2 and FIG. 3 show that a guide shoe 5 may be optionally installed on one or more outside surfaces of the elevator car 1. For example, the guide shoe 5 may be directly installed on an upright column 13 on the side surface of the elevator car 1, so that the elevator car 1, when driven by the power, can travel in the elevator hoistway 7 along the guide rail 2 through the guide shoes 5. It should be pointed out that in the solutions of the disclosure, no specific restrictions are imposed on the specific structural configurations, the numbers and the materials of the guide shoe and the guide rail as well as the engagement mode therebetween. By way of example, a total of two, four or more guide shoes may be equipped on the elevator car in a left-right symmetrical manner, so as to help reduce or avoid problems such as deflection and swing of the elevator car during operation.

With reference to FIGS. 1 to 3 again, a shock absorbing device 3 may be installed on one or more outside surfaces of the elevator car 1 of the elevator system 100. For example, they may be optionally installed on outside surfaces 11 and 12 which are located on left and right sides of the elevator car and are opposed to each other, respectively. At the same time, a buffering device 4 may be correspondingly installed on an inside wall and/or a bottom of the elevator hoistway 7. As an example, the buffering devices 4 may be installed on two mutually opposed positions on a bottom 70 of the elevator hoistway 7, respectively. For another example, they may be installed on inside walls 71 and 72 which are located on left and right sides of the elevator hoistway 7 and are opposed to each other, respectively. In this way, when the elevator car 1 runs to the lowest position in the elevator hoistway 7 along the guide rail 2, the kinetic energy of the elevator car at this point can be absorbed by the mutual contact between the above-mentioned shock absorbing device 3 and the buffering device 4, thereby effectively reducing the generation and impact of vibration, shock, noise, etc.

As an exemplary illustration, in the elevator system 100 given herein, the shock absorbing device 3 may include two or more shock absorbers, and the buffering device 4 may include two or more buffers. The structural shapes, sizes, arrangement positions, numbers, manufacturing materials and the like of these shock absorbers and buffers may be flexibly designed, selected and adjusted according to specific applications needs. In addition, it should also be noted that although the use of completely identical shock absorbers in the elevator system may be very advantageous in terms of manufacturing, installation and maintenance, etc., the disclosure allows for simultaneous use of shock absorbers that are not completely identical to each other in some applications, and this also applies to the buffers in this document.

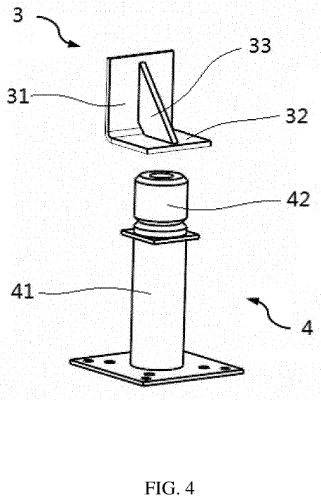

For example, as illustrated in FIGS. 4, 2 and 3, the above-mentioned shock absorber may be configured to have three portions, namely, a fixed portion 31, a contact portion 32 and a reinforcing portion 33. The fixed portion 31 may be fixedly installed to the outside surface of the elevator car 1 (such as the outside surfaces 11 and 12 described above) using any suitable connection method such as welding, screwing and riveting separately or in combination, and the contact portion 32 may be configured to be adapted to contact a buffering portion 42 when the elevator car 1 travels to the lowest position along the guide rail 2 to achieve the advantageous effects of absorbing and reducing vibration, impact energy, and noise. For example, as shown in FIG. 4, the contact portion 32 may be configured to have a relatively large and flat contact surface toward the buffering device 4. The reinforcing portion 33 is disposed between the fixed portion 31 and the contact portion 3 for structural reinforcement purpose, and it may have any possible shape and configuration in practical applications. Of course, in some applications, the disclosure also allows the reinforcing portion 33 to be omitted from the shock absorber, that is, the shock absorber may only have the fixed portion 31 and the contact portion 32. In general, the fixed portion 31, the contact portion 32 and the reinforcing portion 33 may be made of rigid materials such as steel, cast iron, and stainless steel.

Referring again to FIGS. 2 to 4, by way of example only, the above-mentioned buffer may be configured to have two portions, that is, a support portion 41 and the buffering portion 42. Any feasible fixing method may be used to install the support portion 41 at a suitable position on the inside wall and/or bottom of the elevator hoistway 7 to provide a supporting effect, and the buffer portion 42 may be disposed on the support portion 41. Generally, the buffering portion 42 may be made of an elastic material such as polyurethane, rubber, sponge, etc., so as to be able to absorb and reduce impact energy and noise generation when the buffering portion 42 contacts the shock absorber.

It should be understood that for the shock absorbing device and the buffering device in this elevator system, the disclosure is not limited to the specific examples described herein, and each of them can take other more structural forms. For example, as an optional situation, it may be considered to add a spring in the buffering device 4. By way of example, one or more springs may be disposed between the support portion 41 and the buffering portion 42, or in the buffering portion 42, or at these positions simultaneously, so that the effects of absorbing impact energy, reducing vibration, and reducing noise generation are further enhanced.

In addition, a safety device 6 may also be provided in the elevator system 100. For example, it may be installed on one or more outside surfaces of the elevator car 1 (such as the above-mentioned outside surfaces 11 and 12) as shown in FIGS. 1, 2 and 3, so that in the case of an overspeed of the elevator car 1, the safety device 6 can apply a braking force to the elevator car 1 to achieve a safety control, thereby avoiding undesirable personnel and equipment accidents or damage. As for the safety device 6 itself, the disclosure allows any feasible such existing device, equipment or mechanism to be used. For example, a safety gear lifting mechanism or the like may be used.

Additionally, the elevator system 100 can also be optionally equipped with a stopping device. As an example, the stopping device may be installed at any suitable location on the elevator car 1 (such as on one or more outside surfaces), so that a corresponding control switch in the elevator system (which is installed at any suitable position such as at the top or in the interior of the elevator car, at a control end of the elevator system, etc.) is triggered when needed, and then the above stopping device connected to the control switch is used to make the elevator car 1 stop traveling.

The shock absorbing device 3, the buffering device 4, the guide shoe 5, the safety device 6, the stopping device and the like have been introduced above. It is not difficult to find that in the elevator system 100 given as an example, the above components are proposed to be installed on the outside surface of the elevator car or the inside wall and/or bottom of the elevator hoistway correspondingly. By way of example, two or more of the shock absorbing device 3, the guide shoe 5, the safety device 6, and the stopping device may be optionally installed together on at least one outside surface of the elevator car (e.g., on a lower side of the outside surface).

As compared with the disclosure, according to the traditional arrangement, the industry is always accustomed to considering arranging for example a shock absorbing device at the bottom of the elevator car, installing a corresponding buffering device and the like at the bottom of the hoistway and making the buffering device just face the above shock absorbing device. If these solutions in the related art are adopted, it will inevitably be necessary to build a deeper elevator hoistway by excavating at the installation site.

However, the arrangement designed and proposed by the disclosure is obviously different from the above traditional arrangement. The disclosure can minimize the hoistway depth of the elevator system, fully adapt to the complex site installation conditions, effectively reduce the workload of civil construction, and shorten the elevator installation time, thereby reducing the engineering cost. Moreover, the disclosure can also avoid or reduce the adverse effects on the building structure and various underground pipelines during installation and construction. Since the elevator hoistway depth of the elevator system can be significantly reduced, many common existing problems that it is difficult to maintain the elevator and the safety of elevator operation is affected since it is easy to accumulate water due to the deep hoistway can be avoided or alleviated. The above positive aspects are very advantageous for the installation and reconstruction of elevators especially in environments such as old communities, and have successfully solved many problems faced by the traditional way of building hoistway by excavating as discussed above

For example, when additionally installing an elevator for an old building or some other buildings, the elevator hoistway in this elevator system may be completely disposed outside the building. As an example, a steel frame support structure may be adopted for the elevator hoistway, and a full-glass outer wall may be used, or the elevator hoistway is partially disposed outside the building. For example, a steel frame support structure may be adopted for the elevator hoistway, and a part of the outer wall of the building serves as a part of the elevator hoistway. For another example, in an optional situation, the elevator hoistway can be configured such that when the elevator car travels to the lowest position, a floor surface of the car body may be 200-300 mm higher than a site ground surface (usually the horizontal ground surface) of the building. As compared with the existing elevator installation solutions that are currently commonly used, the solution of the disclosure has a small workload of on-site construction, can quickly and efficiently complete the installation and reconstruction of the elevator, and does not cause difficulty in future maintenance and management. Therefore, the disclosure has strong practicability, exhibits quite outstanding technical advantages over traditional technical solutions, and can overcome the disadvantages and deficiencies existing in the related art, including those described in the foregoing.

In another aspect significantly superior to the related art, the disclosure also provides an elevator car, that is, such an elevator car is the elevator car equipped in the elevator system according to the disclosure, wherein the shock absorbing device, the buffering device, the guide shoe, the safety device, the stopping device and/or any other possible component, device or equipment may be installed on one or more outside surfaces of the elevator car as actually required in order to exhibit for example the prominent and outstanding technical advantages of the disclosure as discussed above over the related art.

The elevator system and the elevator car according to the disclosure have been elaborated above in detail by way of example only. These examples are merely used to illustrate the principles and embodiments of the disclosure, rather than limiting the disclosure. Various modifications and improvements can be made by those skilled in the art without departing from the spirit and scope of the disclosure. Therefore, all equivalent technical solutions should fall within the scope of the disclosure and be defined by the claims of the disclosure.

What is claimed is:

1. An elevator system, comprising one or more elevator cars traveling in an elevator hoistway along a guide rail, a shock absorbing device and a buffering device, wherein the shock absorbing device is installed on at least one outside surface of the elevator car, and the buffering device is installed on an inside wall and/or a bottom of the elevator hoistway and configured to contact the shock absorbing device when the elevator car travels to lowest position along the guide rail.

2. The elevator system according to claim 1, further comprising:
a safety device installed on at least one outside surface of the elevator car and configured to apply a braking force to the elevator car when an overspeed occurs in the elevator car; and/or
a stopping device installed on at least one outside surface of the elevator car and connected to a control switch in the elevator system, and configured to make the elevator car stop traveling through the stopping device after the control switch is triggered.

3. The elevator system according to claim 1, wherein the shock absorbing device comprises at least two shock absorbers, the buffering device comprises at least two buffers, the at least two shock absorbers are respectively installed on two mutually opposed outside surfaces of the elevator car, and the at least two buffers are respectively installed on two mutually opposed inside walls of the elevator hoistway and/or two mutually opposed positions on the bottom.

4. The elevator system according to claim 3, wherein the buffers are each configured to have a support portion and a buffering portion, the support portions are installed on the two mutually opposed inside walls and/or the two mutually opposed positions, and the buffering portion are disposed on the support portions and are made of an elastic material.

5. The elevator system according to claim 4, wherein the buffer further has a spring disposed between the support portion and the buffering portion and/or disposed in the buffering portion.

6. The elevator system according to claim 4, wherein the shock absorber is configured to have a fixed portion and a contact portion, the fixed portion is fixed to the two mutually opposed outside surfaces, the contact portion is connected to the fixed portion and contacts the buffering portion when the elevator car travels to the lowest position along the guide rail.

7. The elevator system according to claim 6, wherein the shock absorber further has a reinforcing portion connected to the fixed portion and the contact portion.

8. The elevator system according to claim 2, wherein the outside surface of the elevator car is provided with a guide shoe, the elevator car travels in the elevator hoistway along the guide rail through the guide shoe, and at least two of the guide shoe, the shock absorbing device, the safety device, and the stopping device are installed together on at least one outside surface of the elevator car.

9. The elevator system according to claim 8, wherein the guide shoe, the shock absorbing device, the safety device, and the stopping device are all installed on a lower side of at least one outside surface of the elevator car.

10. The elevator system according to claim 1, wherein the elevator hoistway is at least partially disposed outside of a building where the elevator system is installed.

11. The elevator system according to claim 1, wherein when the elevator car is at the lowest position, a floor surface of the elevator car is 200-300 mm higher than a site ground surface of the building where the elevator system is installed.

12. An elevator car, wherein the elevator car is the elevator car in the elevator system according to claim 1.
